(19) United States
(12) Patent Application Publication
(10) Pub. No.: US 2004/0066702 A1
(43) Pub. Date: Apr. 8, 2004

(54) Wall mounted compost irrigation system

(76) Inventors: Richard M. Nicoletti, Petersham, MA (US); Jerome T. Wright, Rapid City, SD (US); Paul J. Gormsen, Barre, VT (US); E. Dallas Wasserburger, Rapid City, SD (US)

Correspondence Address: Thomas G. Field III, Peter C. Lando, Wolf, Greenfield & Sacks, P.C., 600 Atlantic Avenue, Boston, MA, 02210, US

(21) Appl. No.: 10/262,554

(22) Filed: Sep. 30, 2002

(51) Int. Cl. B05B 15/06

(52) U.S. Cl. 366/23; 239/70; 239/200

(57) ABSTRACT

The present invention is directed to irrigation devices, and, more specifically, to wall mounted irrigation systems for compost. According to one embodiment of the present invention, a compost irrigation system is provided, including a first wall and a second wall defining a first compost compartment. The compost irrigation system also includes an irrigant source, a first nozzle mounted on at least one of the first and second walls and arranged to direct an irrigant into the first compost compartment, and an irrigant flow system fluidly connecting the irrigant source to the first nozzle.

According to another embodiment of the present invention, a method of treating compost is provided. The method includes providing a compost irrigation system, providing a first volume of compost to a first compost compartment and spraying the irrigant through a first nozzle into the first compost compartment. In this embodiment, the compost irrigation system includes a first wall and a second wall defining the first compost compartment, an irrigant source, the first nozzle mounted on at least one of the first and second walls and arranged to direct an irrigant into the first compost compartment, and an irrigant flow system fluidly connecting the irrigant source to the first nozzle.

### FIELD OF THE INVENTION

The present invention is directed to irrigation devices, and, more specifically, to wall mounted irrigation systems for composting systems.

### BACKGROUND OF THE INVENTION

Various composting procedures have been proposed or developed to provide improved disposal of municipal refuse, sewage, sludge, plant waste and similar biodegradable materials. The advantages attendant with this form of treatment include, for instance, the compost or end product being significantly reduced in volume. Additionally, the compost may have commercial value as a fertilizer, for example.

With one composting procedure, organic waste is mixed with a bulking agent and then deposited in an input end of a elongated bay. Each day the waste is moved a certain distance along the bay and new waste, also mixed with a bulking agent, is added to the input end of the bay. As the waste moves along the bay, it is aerated and gradually changes into a stable, commercially useable compost, and at this point, the compost is removed from the bay.

With this procedure, a machine is used both to help aerate and mix the compost and to move it through the bay. This machine includes a carriage that moves over the compost. The carriage is mounted on a pair of rails secured to top lateral edges of the walls of bay. A conveyor assembly extends downward from the carriage and into the bay, and an agitating drum is supported forward of the conveyor assembly. In use, the conveyor assembly operates to lift the compost and displace it along the bay a certain distance, and the agitating drum is rotated against the compost to agitate, mix and grind the compost prior to its engagement with the conveyor assembly.

Composting machines, systems and facilities are described in more detail in U.S. Pat. Nos. 4,828,399, 4,869,877, 5,149,196, and 5,387,036, which are hereby incorporated herein in their entirety.

### SUMMARY OF THE INVENTION

According to one embodiment of the present invention, a compost irrigation system is provided, including a first wall and a second wall defining a first compost compartment. The compost irrigation system also includes an irrigant source, a first nozzle mounted on at least one of the first and second walls and arranged to direct an irrigant into the first compost compartment, and an irrigant flow system fluidly connecting the irrigant source to the first nozzle.

According to another embodiment of the present invention, a method of treating compost is provided. The method includes providing a compost irrigation system, providing a first volume of compost to a first compost compartment and spraying the irrigant through a first nozzle into the first compost compartment. In this embodiment, the compost irrigation system includes a first wall and a second wall defining the first compost compartment, an irrigant source, the first nozzle mounted on at least one of the first and second walls and arranged to direct an irrigant into the first compost compartment, and an irrigant flow system fluidly connecting the irrigant source to the first nozzle.

Other advantages, novel features, and objects of the invention will become apparent from the following detailed description of non-limiting embodiments of the invention when considered in conjunction with the accompanying drawings, which are schematic and which are not intended to be drawn to scale. In the figures, each identical or nearly identical component that is illustrated in various figures typically is represented by a single numeral. For purposes of clarity, not every component is labeled in every figure, nor is every component of each embodiment of the invention shown where illustration is not necessary to allow those of ordinary skill in the art to understand the invention. In cases where the present specification and a document incorporated by reference include conflicting disclosure, the present specification shall control.

### BRIEF DESCRIPTION OF THE DRAWINGS

FIG. 1 is a perspective, plan view of a compost irrigation system according one embodiment of the present invention;

FIG. 2 is a perspective, plan view of a portion of the compost irrigation system of FIG. 1;

FIG. 3 is a cut-away view of a portion of the compost irrigation system of FIG. 1;

FIG. 4 is a side view of a portion of the compost irrigation system of FIG. 1;

FIG. 5 is a cut-away view of a portion of the compost irrigation system of FIG. 1;

FIG. 6 is a side, elevational view of a portion of the compost irrigation system of FIG. 1; and

FIG. 7 is a top, elevational view of a portion of the compost irrigation system of FIG. 1.

### DETAILED DESCRIPTION

It may be desirable to provide irrigation to composting systems for a variety of reasons, including providing moisture content for microbial activity and dust control. To improve the effectiveness of irrigation, the compost may be agitated after irrigation, dispersing the irrigant throughout the compost and thereby making it more easily accessed by microbes and slowing evaporation. Because conventional irrigation systems for compost are typically suspended above an area containing compost in a plurality of adjacent compost bays, such systems may irrigate all bays at once. As compost is typically agitated and advanced in each bay separately, this may not result in optimum timing for the irrigation in each bay. Furthermore, suspended irrigation systems are typically not easily accessible for maintenance when required.

The present invention recognizes the problems associated with non-specific irrigation systems and, in one embodiment, solves these problem with a compost irrigation system that provides directed irrigation. The present invention also recognizes that typical compost irrigation systems are difficult to maintain because they are not easily accessible, and also addresses this issue. Furthermore, the present invention recognizes the benefits of timing irrigation with agitation, and, in one embodiment, provides a compost irrigation system capable of coordinating compost irrigation with compost agitation.

In one embodiment, the present invention is directed to a compost irrigation system including a first wall and a second wall defining a first compost compartment. The compost irrigation system further includes an irrigant source, a first nozzle mounted on at least one of the first and second walls and arranged to direct irrigant into the first compost compartment, and an irrigant flow system fluidly connecting the irrigant source to the first nozzle. As used herein, “compost compartment” refers to any area designated to contain compost and having at least two walls separating it from other areas. A compost compartment may be provided in a conventional elongated bay arrangement. As used herein, “compost” refers to any primarily organic waste, or combination of wastes, having sufficiently high solids content so as not to flow. As used herein, “irrigant” refers to any liquid which may be desired to be added to compost, such as water and aqueous solutions.

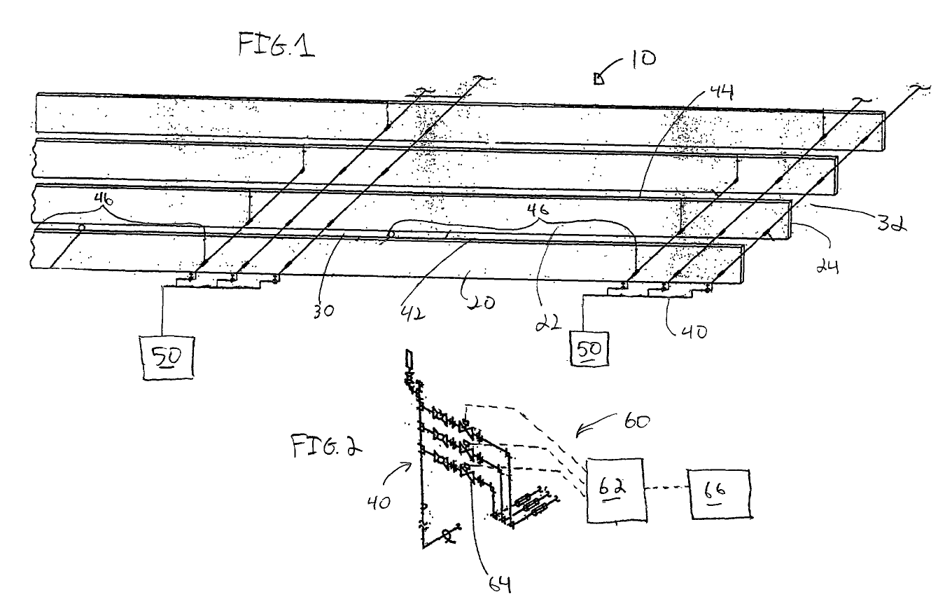

Referring now to the figures, and particular FIG. 1, an embodiment of a compost irrigation system according to the present invention will be described by way of example. In this embodiment, a compost irrigation system 10 includes a first wall 20 and a second wall 22 defining a first compost compartment 30. Compost irrigation system 10 further includes an irrigant source 50, a first nozzle 42 mounted on at least one of first and second walls 20, 22 and arranged to direct irrigant into first compost compartment 30, and an irrigant flow system 40 fluidly connecting irrigant source 50 to first nozzle 42.

First and second walls 20, 22 may be constructed in any manner and using any materials that are sufficiently durable to maintain the compost within first compost compartment 30. For example, walls 20, 22 may be constructed of a relatively strong, moisture resistant, and inexpensive material. In one embodiment, walls 20, 22 may be constructed of concrete, cinder blocks, or the like. As will be described in more detail below, walls 20, 22 may be adapted to contain portions of irrigant flow system 40 therein. Walls 20, 22 also may be sufficiently thick to have acceptable durability and to adequately contain the compost. The appropriate thickness may vary with the material the walls are constructed from and their manner of construction. Walls 20, 22 may also be thick enough to contain desired portions of compost irrigation system 20. In certain embodiments where an agitator or other piece of equipment is to be supported by the walls, the walls may also be strong enough to support this equipment. Walls 20, 22 may have structure adapted to support such equipment. For example, walls 20, 22 may include a guide rail 26 mounted thereto, upon which equipment may be supported and moved.

Walls 20, 22 may be sufficiently long and high to provide a desired residence time and depth of the compost. For example, the height of the walls may be selected to exceed the maximum desired compost depth. As another example, where an elongated bay arrangement is used, the length of the walls may be selected based upon the rate at which compost is moved through the bay and the amount of time it is desired to treat the compost. It should also be appreciated that the width of the bay may be adjusted in addition to, or instead of, the length of the bay. The compost compartment may have any shape suitable for housing compost and compartment arrangements other than linear bays may be used.

An irrigant source may comprise a holding tank or other supply of irrigant, depending on the nature of the irrigant. For example, where water is the irrigant, the irrigant source may comprise a municipal water supply or well. Materials, such as 10 additives, may be added to the irrigant in-line or in a mixing tank prior to irrigation.

Irrigant flow system 40 may be constructed in any manner and using any materials that allow it to direct irrigant from the irrigant source to nozzle 42. For example, irrigant flow system 40 may include a series of pipes, channels, or other flow paths capable of guiding the irrigant to the nozzle. The flow system may be constructed of materials compatible with the irrigant to be flowed though them. Typically, polyvinylchloride (PVC) piping or other similar common piping is sufficiently inert to be compatible with the irrigant.

The irrigant flow system may be sized and configured to allow a desired amount of irrigant to be supplied with an acceptable head loss. For example, where piping is used, its diameter may be selected based on the desired flow rate, number of nozzles, and the like, and may vary throughout the system. The irrigant flow system may be configured such that only certain portions, or lengths, of the compost compartment are irrigated.

Irrigant flow system 40 may be arranged in any manner able to supply fluid from the irrigant source to the nozzle. In certain embodiments, it may be preferred to limit potential interference of the irrigant system on the workings of the compost system as a whole. For example, the irrigant flow system may be positioned such that it is out of the way by burying it, positioning portions thereof in the wall, or the like. For example, where agitators, or other equipment, is to be mounted on the walls, and will fill nearly all of the compost compartment when in operation, the irrigant flow system may direct irrigant under the compost compartment and up through the walls to the nozzle such that any piping in the system does not interfere with the agitator and/or other equipment.

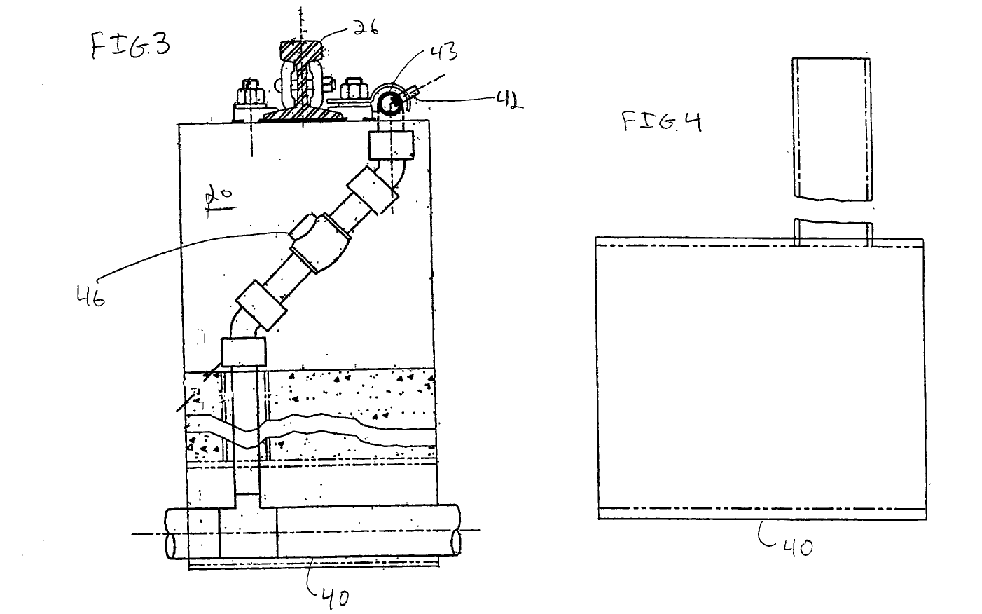

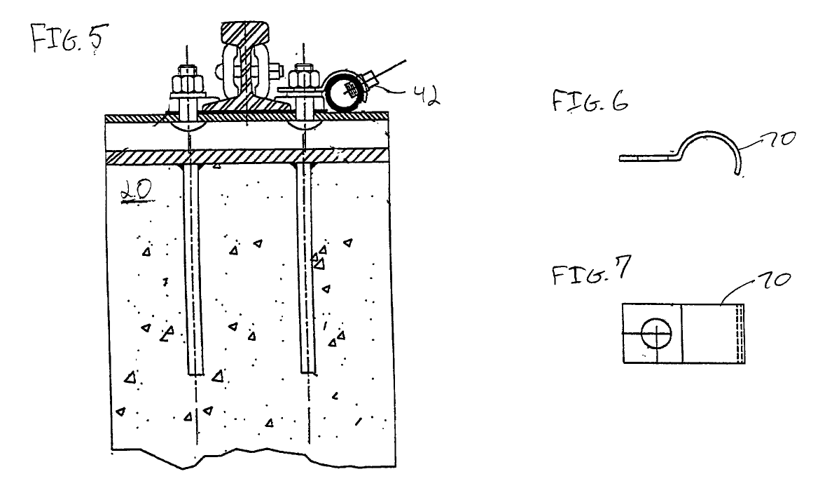

FIGS. 3, 4 and 5 illustrate an irrigant flow system mounted in a wall. As illustrated in FIG. 3, a valve 46, which may or may not be connected to a control system as described below, may be positioned in the wall to control, or eliminate, irrigant flow to a nozzle header 43 and nozzle 42 mounted on the top on the wall. FIG. 4 shows a close-up view of a wall sleeve device, which, in this embodiment, is permanently set or cast into the wall during construction of the wall. Through this wall sleeve, the irrigation piping runs from beneath the wall, into the wall, and to the top of the wall as illustrated in FIG. 3. FIG. 5 shows the top of the wall and a manner in which the irrigant flow system may be mounted to the wall using the hold down clips 70 of FIGS. 6 and 7.

Referring now also to FIG. 2, in some embodiments, an irrigant flow system 40 may be connected to an irrigation control system 60. Irrigation control system 60 may allow flow through irrigant flow system 40 to be controlled and/or monitored. In one embodiment, irrigation control system 60 may include a controller 62 and a first valve 64 positioned in the irrigant flow system for controlling flow to the first nozzle and operatively connected to controller 62. As used herein, “operatively connected” means connected in such a manner that the control may be exerted. For example, the connection may be pneumatic, electrical, hydraulic, or some combination thereof. In certain embodiments, the irrigation control system may further comprise an input device 66 adapted to receive a signal representing an irrigation schedule and a pressure sensor for monitoring system pressure.

A controller for use in an irrigation control system may be constructed in any manner and using any materials that allow it to provide the control to execute a desired irrigation schedule. Typically, the controller may be microprocessor based, but analog and other controllers also may be used. The complexity of the controller may vary with the complexity of the irrigation system and desired irrigation schedule. For example, in one embodiment, the controller may be as simple as a timer that opens and closes a valve, while in others, a series of valves may be controlled in a complex and varying schedule throughout a plurality of compost compartments.

In certain embodiments, the irrigation control system may be part of a larger composting control system. For example, the irrigation control system may be part of a composting control system including logic code for controlling agitation and movement of compost through the first compost compartment. Such an arrangement may facilitate synchronization of the irrigation and agitation times to improve the effectiveness of the irrigation. Whether or not they are part of the same system, the composting control system and irrigation control system 60 may be adapted to communicate to provide irrigation at pre-selected times in a composting schedule. The exact nature of this coordination may vary with the specific embodiment, but will typically include irrigating the compost some period in advance of agitating it. For example, the compost could be irrigated no more than 3 hours before agitation, no more than one hour before agitation, no more than 15 minutes before agitation, or even closer to the scheduled agitation time.

Referring now also to FIGS. 3 and 5, nozzle 42 may be constructed in any manner and using any materials that allow it to provide sufficient flow, sufficiently accurately for a given compost irrigation application. For example, in certain embodiments of the present invention, the nozzle is sized and arranged to deliver at least 80%, 90%, 95%, or 98% of the irrigant passing through the nozzle to the first compost compartment. In other embodiments, substantially all of the irrigant passing through the nozzle is delivered to the first compost compartment. Nozzle 42 may be achieve the desired accuracy and flow rate in several ways. For example, it may include a sufficiently large opening or openings to provide a desired flow of irrigant at a given pressure and may be shaped and arranged to direct the flow of irrigant as desired. It should be recognized that the force with which the irrigant leaves the nozzle may also affect the way the irrigant is supplied. Accordingly, the pressure at the nozzle may be adjusted, for example using the irrigant flow rate and the size of any opening or openings in the nozzle. The angle of the opening or openings in the nozzle may also be adjusted to direct irrigant as desired. For example, an angle may be selected based on the pressure at the nozzle such that the furthest reach of the irrigant is below the top of the opposite wall, maintaining substantially all of the irrigant in the desired compost compartment. Typically, this angle will be (with respect to the wall) between about 90 and 150 degrees, but may be lower, for example where the walls are relatively high compared to the compost, or higher, for example where the irrigant pressure is relatively low, or the compost compartment is particularly broad.

Nozzles for use in the present invention may also be adapted to provide irrigant along a length of an extended bay. For example, a series of nozzles may be mounted on extended member, such as a pipe acting as a nozzle header, such that irrigant is supplied out of these nozzles along a desired spray area 46. The nozzles may be spaced to provide sufficiently even irrigation for a given application. For example, nozzles may be placed every 160 inches, every 80 inches, every 40 inches, every 20 inches, or the like, along the wall in the spray area or areas. Because composting is an exothermic process, some evaporation of irrigant is expected. Accordingly, it may not be enough to irrigate only the beginning, or some other single portion of, the compost compartment. Irrigation may be supplied at various regions throughout the comport compartment, such as along different lengths of a bay in a bay-shaped compost compartment, such that irrigation is sufficient throughout the compost compartment. Some compost irrigation systems may have the capability of providing irrigation throughout the compost irrigation compartment.

As illustrated in FIG. 1, embodiments of the compost irrigation system of the present invention may include more than one compost compartment. For example, a third wall 24 may be positioned to define a second compost compartment 32 with second wall 22 and a second nozzle 44 may be mounted on one of second and third walls 22, 24 and arranged to direct irrigant into second compost compartment 32. This pattern may be repeated by adding any number of walls and nozzles, allowing any number of compost compartments may be provided.

In some embodiments including multiple compost compartments, irrigation system 40 may comprise several parts. For example, as illustrated in FIG. 1, different pipes or other irrigant conduits may lead to different nozzles, or a few nozzles may be connected to a single pipe acting as a nozzle header. Where several nozzles share a common pipe, they may all receive irrigant at the same time, or may each be associated with their own valve so that control of each individual nozzle may be exercised.

While several embodiments of the invention have been described and illustrated herein, those of ordinary skill in the art will readily envision a variety of other means and structures for performing the functions and/or obtaining the results or advantages described herein, and each of such variations or modifications is deemed to be within the scope of the present invention. More generally, those skilled in the art would readily appreciate that all parameters, dimensions, materials, and configurations described herein are meant to be exemplary and that actual parameters, dimensions, materials, and configurations will depend upon specific applications for which the teachings of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, material and/or method described herein. In addition, any combination of two or more such features, systems, materials and/or methods, if such features, systems, materials and/or methods are not mutually inconsistent, is included within the scope of the present invention.

In the claims (as well as in the specification above), all transitional phrases such as “comprising,” “including,” “carrying,” “having,” “containing,” “involving,” and the like are to be understood to be open-ended, i.e. to mean including but not limited to. Only the transitional phrases “consisting of” and “consisting essentially of” shall be closed or semi-closed transitional phrases, respectively, as set forth in the United States Patent Office Manual of Patent Examining Procedures, section 2111.03.

What is claimed is:

1. A compost irrigation system, comprising:
a first wall and a second wall defining a first compost compartment;
an irrigant source;
a first nozzle mounted on at least one of the first and second walls and arranged to direct an irrigant into the first compost compartment; and
an irrigant flow system fluidly connecting the irrigant source to the first nozzle.

2. The compost irrigation system of claim 1, further comprising:
an irrigation control system, including:
a controller; and
a first valve positioned in the irrigant flow system for controlling flow of the irrigant to the first nozzle and operatively connected to the controller.

3. The compost irrigation system of claim 2, wherein the irrigation control system further comprises an input device adapted to receive a signal representing an irrigation schedule.

4. The compost irrigation system of claim 2, wherein the irrigation control system is part of a composting control system.

5. The compost irrigation system of claim 4, wherein the composting control system comprises logic code for controlling agitation and movement of a compost through the first compost compartment.

6. The compost irrigation system of claim 5, wherein the composting control system and irrigation control system are adapted to communicate to provide irrigation at pre-selected times in a composting schedule.

7. The compost irrigation system of claim 6 wherein the compost control system comprises logic code to initiate agitation of the compost within 3 hours of the compost being irrigated.

8. The compost irrigation system of claim 1, wherein the first nozzle is sized and arranged to deliver at least 90% of the irrigant passing through the first nozzle to the first compost compartment.

9. The compost irrigation system of claim 8, wherein the first nozzle is sized and arranged to deliver substantially all of the irrigant passing through the first nozzle to the first compost compartment.

10. The compost irrigation system of claim 1, further comprising:
a third wall defining a second compost compartment with the second wall; and
a second nozzle mounted on at least one of the second and third walls and arranged to direct the irrigant into the second compost compartment;
wherein the irrigant flow system fluidly connects the irrigant source to the second nozzle.

11. The compost irrigation system of claim 1, wherein the irrigant flow system is at least partially positioned in at least one of the first and second walls.

12. A method of treating compost, comprising:
providing a compost irrigation system, comprising:
a first wall and a second wall defining a first compost compartment;
an irrigant source;
a first nozzle mounted on at least one of the first and second walls and arranged to direct an irrigant into the first compost compartment; and
an irrigant flow system fluidly connecting the irrigant source to the first nozzle;
providing a first volume of compost to the first compost compartment; and
spraying the irrigant through the first nozzle into the first compost compartment.

13. The method of claim 12, wherein spraying comprises spraying the irrigant such that at least 90% of the irrigant passing through the first nozzle is provided to the first compost compartment.

14. The method of claim 13, wherein spraying comprises spraying the irrigant such that substantially all of the irrigant is provided to the first compost compartment.

15. The method of claim 12, wherein spraying comprises at least partially opening a valve in the irrigant flow system.

16. The method of claim 15, wherein opening the valve comprises sending a signal from an irrigation control system comprising logic code for initiating irrigation at a pre-selected time.

17. The method of claim 12, further comprising agitating the compost in the compost compartment no more than 3 hours after irrigating the compost.

18. The method of claim 12, further comprising removing a second volume of compost from the first compost compartment.

19. The method of claim 18, further comprising adding a third volume of compost to the first compost compartment, the third volume of compost being substantially equal to the second volume of compost.
